(19) United States
(12) Patent Application Publication
(10) Pub. No.: US 2014/0135993 A1
(43) Pub. Date: May 15, 2014

(54) METHOD AND APPARATUS FOR MANAGING ENERGY IN HOME

(71) Applicant: ELECTRONICS AND TELECOMMUNICATIONS RESEARCH INSTITUTE, Daejeon (KR)

(72) Inventors: Shin Yuk KANG, Daejeon (KR); IL Woo LEE, Daejeon (KR)

(73) Assignee: ELECTRONICS AND TELECOMMUNICATIONS RESEARCH INSTITUTE, Daejeon (KR)

(21) Appl. No.: 13/895,515

(22) Filed: May 16, 2013

(30) Foreign Application Priority Data
Nov. 13, 2012 (KR) 10-2012-0128295

(51) Int. Cl. G05B 15/02

(52) U.S. Cl. CPC G05B 15/02
USPC 700/275

(57) ABSTRACT

An apparatus for managing energy in a home, the apparatus includes a device interface unit configured to communicate with at least one of a home appliance and a home automation device that are placed in a home; and an information collection unit that stores identifiers and status information of the home appliance and home automation device received through the device interface unit. Further, the apparatus includes an operation controlling unit configured to control the operation of the home appliance and home automation device in line with the status information.

### CROSS-REFERENCE TO RELATED APPLICATION(S)

The present invention claims priority of Korean Patent Application No. 10-2012-0128295, filed on Nov. 13, 2012, which is incorporated herein by reference.

### FIELD OF THE INVENTION

The present invention relates to an energy management apparatus and method in a home; and more particularly, to an apparatus and method for managing energy in a home with a capability of energy saving without any individual operation, in which home appliances having an energy saving capability or an energy controlling capability are cooperated one another in order to save the energy so that they are controlled in line with surrounding environment information, use information about a user, energy cost information and the like.

### BACKGROUND OF THE INVENTION

With an increase in an energy use more and more, as a part of an energy saving in a home, techniques that individual home appliances can be operated in a power saving mode have been developed and the related products have been coming into a market. In recent years, have also been developed and come into the market is smart home appliances that the appliances receive information on electricity rates that are imposed by time so that they operate in a power saving mode during high electricity rates and operate in a normal mode during a low electricity rates.

On the other hand, as one of plans of doing a favor for a user at indoor and outdoor of a building or home and of performing surveillance function from external intruders, home automation system is introduced for applying. The Home automation system is a system that a user can remotely control from outside air conditioners, heaters, television sets, lighting devices, and the like that are placed in indoor and outdoor.

To control the home appliances individually may be simple; however, it is difficult to expect effective energy savings.

### SUMMARY OF THE INVENTION

In view of the above, the present invention provides an apparatus and method for managing energy in a home with a capability of an efficient energy saving, in which home appliances that are placed in the home as well as smart home appliances that are operated in a saving mode are cooperated one another so that they are controlled mutually.

In accordance with an aspect of the present invention, there is provided an apparatus for managing energy in a home. The apparatus includes a device interface unit configured to communicate with at least one of a home appliance and a home automation device that are placed in a home; an information collection unit that stores identifiers and status information of the home appliance and home automation device received through the device interface unit; and an operation controlling unit configured to control the operation of the home appliance and home automation device in line with the status information.

Further, the status information may comprise information on a current operational status of the home appliances and home automation devices and surrounding environment information.

Further, the operation controlling unit may be configured to produce an authorization approval signal for the connection to the home appliance and home automation device using a master identifier.

Further, the operation controlling unit may be configured to produce an information request signal for requesting the status information to the home appliance and home automation device.

Further, the device interface unit may be configured to communicate with an external server through an Internet-based network.

Further, the information collection unit may be configured to receive external underlying information for the storage thereof from the external server.

Further, the external underlying information may comprise an energy consumption and electricity rates by time, current external temperature, a weather change, and a temperature change.

Further, the operation controlling unit may be configured to analyze the status information and external underlying information, produce an operation control sequence having a minimum energy consumption by time, and may produce the operation control signal in line with the operation control sequence.

Further, the operation controlling unit may be configured to produce a user approval request signal for receiving the approval of the operation control sequence from the user

Further, the operation controlling unit may be configured to produce a user alarm signal for informing the operation of the home appliance and the home automation device.

Further, the apparatus may further comprise a user interface unit configured to receive the user approval request signal and forward the received one to the user, and receive one of an approval signal and a rejection signal and forward the received one to the operation controlling unit.

In accordance with a second aspect of the present invention, there is provided a method for managing energy in a home. The method includes sending an authorization approval signal including a master identifier to at least one of a home appliance and a home automation device that are placed in the home; receiving the approval of the connection to the home appliance and home automation device using the master identifier; sending an information request signal to the home appliance and the home automation device; receiving identifiers and status information on the home appliance and the home automation device; and producing an operation control signal to forward the same to the home appliance and the home automation device.

Further, said producing the operation control signal may comprise producing an operation control sequence having a minimum energy consumption by time.

Further, the method may further comprise after said producing the operation control signal, producing a user approval request signal to forward it to the user; and receiving one of an approval signal and a rejection signal from the user.

In accordance with an embodiment of the present invention, it is possible to provide an apparatus and method for managing energy in a home with a capability of an efficient energy saving, in which home appliances that are placed in the home as well as smart home appliances that are operated in a saving mode are cooperated one another so that they are controlled mutually.

### BRIEF DESCRIPTION OF THE DRAWINGS

The above and other objects and features of the present invention will become apparent from the following description of the embodiments given in conjunction with the accompanying drawings, in which:

FIG. 1 is a block diagram of an apparatus for managing energy in a home in accordance with an exemplary embodiment of the present invention; and

FIG. 2 shows a detailed block diagram of the apparatus for managing energy in a home in accordance with an exemplary embodiment of the present invention.

### DETAILED DESCRIPTION OF THE EMBODIMENTS

Detailed description of the present invention will be described below with reference to the accompanying drawings illustrating specific embodiments of the present invention. These embodiments are described in detail so that those skilled in the art can easily practice the present invention. It should be understood that the various embodiments of the present invention are different from each other, but need not be mutually exclusive. For example, a particular shape, structure and properties that are described herein and are related to one embodiment of the present invention may be implemented with other embodiments without departing the scope of the present invention. Further, it should be understood that the location and arrangement of the individual components in the embodiments may be changed without departing the scope of the present invention. Therefore, the detailed description below is rather than those that try to take as a limiting sense if it is explained properly, the scope of the present invention is only limited by all ranges identical to those that it claims, and the appended claims. Like reference numerals refer to the same or similar elements throughout the drawings.

Hereinafter, the embodiments of the present invention will be described in detail with reference to the accompanying drawings which form a part hereof.

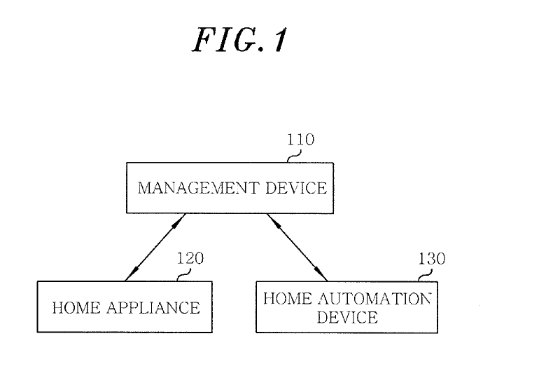

FIG. 1 is a block diagram of an apparatus for managing energy in a home in accordance with an exemplary embodiment of the present invention.

Referring to FIG. 1, an apparatus for managing energy in a home of the embodiment includes a management device 110, home appliances 120 and home automation devices 130. Herein, the management device 110 serves to as a master device for controlling the home appliances 120 and the home automation devices 130. Although the exemplary embodiment of the present invention describes that one management device controls a plurality of the home appliances 120 and home automation devices 130, it should be noted that the embodiment is not limited thereto and a plurality of the home appliances 120 and home automation devices 130 may be controlled by plural management devices.

The management device 110 includes a computing unit for storing and analyzing an energy use pattern in a home. For example, the management device 110 may include an IHD (In Home Intelligence Display), a wall pad, and a smart home appliance, etc. The home appliances 120 forward information on a current operational status and a surrounding environment to the management device 110 and are under a control of the management device 110. For example, the home appliances 120 may include refrigerators, air conditioners, washing machines, television sets, heaters and the like. Also, the home automation devices 130 may also be controlled by the management device 110 and may include, for example, controlled curtains, window openers, lighting devices and the like.

The management device 110, the home appliances 120 and the home automation devices 130 in accordance with the embodiment of the present invention can communicate with one another via a wireless communication, power line communication (PLC), RS485 communication in order to send and receive information therebetween. And, the management unit 110, the home appliances 120 and the home automation devices 130 are distinguished by their unique identifiers, and the management device 110 may include a master identifier for representing the master device.

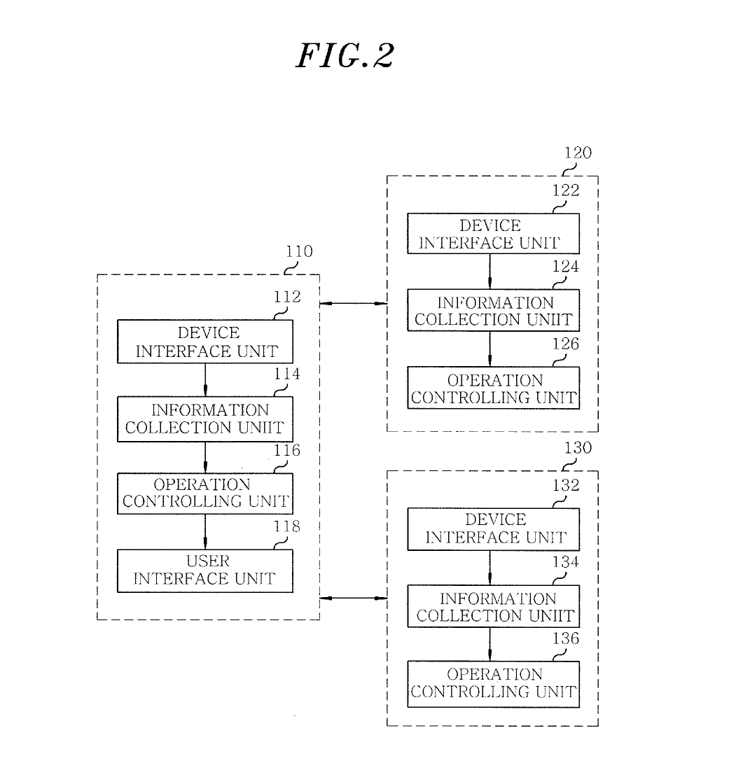

FIG. 2 shows a detailed block diagram of the apparatus for managing energy in a home in accordance with an exemplary embodiment of the present invention.

Referring to FIG. 2, the management device 110 of the embodiment includes a device interface unit 112, an information collection unit 114, an operation controlling unit 116, and a user interface unit 118. The device interface unit 112 communicates with the home appliances 120 and the home automation devices 130 and may communicate with an external server (not shown) through an Internet-based network.

The information collection unit 114 receives the identifiers and status information of the home appliances 120 and the home automation devices 130 for the storage thereof through the device interface unit 112 and receives external underlying information from the external server for the storage thereof. In this regard, the status information may include a current operational status for the home appliances 120 and the home automation devices 130, user use information, surrounding environment information and the like. For example, in a case where the home appliance 120 is an air conditioner, the status information may be temperature and humidity in a home, external temperature, wind speed, and humidity, etc. via an outdoor unit. Also, the status information may be temperature and humidity in a home when the air conditioner is under an operation.

Similarly, in a case where the home appliance 120 is a refrigerator, the status information may be inner temperature in the refrigerator, an amount and kind of the food and drink within the refrigerator, and the likes. Also, the status information may include the use time during the refrigerator is in use, the numbers and time that the door of the refrigerator opens and closes, and the temperature change in the refrigerator depending on the refrigerator in use, and the like.

In a case where the home appliance 120 is a washing machine, the status information may be an amount of the laundries in a washing tub, a use pattern of the washing machine by the user and the like. In a case where the home appliance 120 is a television set, the status information may be a Television viewing time, and the likes. Meanwhile, at least one of the home appliances 120 may forward the information about the user in a home as the status information via sensors, cameras or by way of a direct input scheme by the user. The information about the user may include the number of the members dwelling in the home, age of the members, and a residence time and the like.

Although the exemplary embodiment of the present invention describes that the home appliances 120 include sensors, it should be noted that the embodiment is not limited thereto and the status information may be collected from separate external sensors and the like.

Further, the external underlying information may be energy consumption and electricity rates by time, external weather such as current external temperature and weather change, temperature change, and an energy saving method at the other homes.

The operation controlling unit 116 may produce an operation control signal to control the operations of the home appliances 120 and the home automation devices 130 in accordance with the status information and external underlying information. More specifically, the operation controlling unit 116 analyzes the status information and external underlying information to produce an operation control sequence having a minimum energy consumption by time, and produces the operation control signal adapted for the operation control sequence.

For example, in an environment where the temperature change between current external temperature and temperature in a room maintains within a constant range without fluctuation and the windy weather is apt to blow a wind into the home, the operation controlling unit 116 may produces an operation control sequence that controls the home automation devices 130 to open the window, raises a curtain, open the door of each room, and controls the home appliances 120 to stop an air conditioner, and turn on an electric fan.

Further, when the refrigerator is not in use by a user and the refrigerator contains a food that would not decayed even at temperature higher than current temperature in the refrigerator, the operation controlling unit 116 may produce an operation control sequence that operates the refrigerator in a power saving mode for a longer time than the time zone having highest electricity rates and operates the refrigerator in a normal mode when the temperature in the refrigerator goes high over a predetermined temperature range.

Further, in a case of a home appliance such as a washing machine that is operated only for some period of time, the operation controlling unit 116 may produce an operation control sequence that operates the washing machine at the time zone having a minimum energy consumption and when the amount of laundry is within a predetermined range.

Further, for winter, the operation controlling unit 116 may produce an operation control sequence that raises a curtain at the time zone of a strong sunlight, depending on the weather information via the Internet to raise the temperature in a home. And, the operation controlling unit 116 may produce an operation control sequence that turns on an air conditioner by determining a going in and out, i.e., an attendance hour and closing hour or turn off a lighting device at a sunshiny time zone.

Further, the operation controlling unit 116 may produce an authorization approval signal for access to the home appliances 120 and the home automation devices 130 using the master identifier and then produce an information request signal to request the status information to the home appliances 120 and the home automation devices 130. Herein, the information request signal may be periodically generated in a predetermined time interval. In addition, the operation controlling unit 116 may produce a user approval request signal for receiving the approval of the operation control sequence from the user and produce a user alarm signal to inform the user of the operation of the home appliances 120 and the home automation devices 130.

The user interface unit 118 receives the user approval request signal from the operation controlling unit 116 and forwards the same to the user, and receives any one of an approval signal and a rejection signal from the user and forwards the same to the operation controlling unit 116. To do it, it is preferable that the user installs on a smart phone or the like an application that enables the user to select whether or not to accept the operation sequence so that the user can communicate with the user interface unit 118.

The home appliance 120 includes a device interface unit 122, an information collection unit 124 and an operation controlling unit 126. The device interface unit 122 receives the authorization approval signal to approve the access to any appliance or device of the management device 110 and forwards the identifier and the status information thereof to the management device 110. The information collection unit 124 collects the status information on the appliance or device, and the operation controlling unit 126 controls the corresponding appliance or device.

The home automation device 130 includes a device interface unit 132, an information collection unit 134 and an operation controlling unit 136. The device interface unit 132 receives the authorization approval signal to approve the access of the management device 110 and forwards the identifier and the status information thereof to the management device 110. The information collection unit 134 collects the status information of the devices, and the operation controlling unit 136 controls the corresponding devices.

Hereinafter, a description will be made on a method for managing energy in a home in accordance with an exemplary of the present invention.

First, the management device 110 in a home sends an authorization approval signal to each of the home appliances 120 and the home automation devices 130. The home appliances 120 and the home automation devices 130 perceive the authorization approval signal and determine whether to approve the access of the management device 110. When the access of the management device 110 is approved, the management device 110 forwards the information request signal to the home appliances 120 and the home automation devices 130. The home appliances 120 and the home automation devices 130 then forward their status information to the management device 110.

In response thereto, the management device 110 produces an operation control signal in accordance with the collected status information and the external underlying information. Also, the management device 110 generates the user approval request signal for receiving the approval from the user, and when obtaining the approval from the user, transmits the operation control signal both the home appliances 120 and the home automation devices 130. Accordingly, the home appliances 120 and the home automation devices 130 are operated in accordance with the operation control signal.

As described above, in accordance with the exemplary embodiment of the present invention, the apparatus and method for managing energy in a home may save energy without any individual operation of the home appliances having an energy saving capability or an energy controlling capability that are cooperated one another and are controlled in line with surrounding environment information, use information of a user, energy cost information.

Further, the present invention is not limited to the above, and may forward the operation sequence for the energy saving depending on the user use pattern to an external service subscriber or a utility provider allowing the other households to search and utilize the information on the energy saving sequence, thereby spreading the energy saving.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for managing energy in a home, the apparatus comprising:
a device interface unit configured to communicate with at least one of a home appliance and a home automation device that are placed in a home;
an information collection unit that stores identifiers and status information of the home appliance and home automation device received through the device interface unit; and
an operation controlling unit configured to control the operation of the home appliance and home automation device in line with the status information.

2. The apparatus of claim 1, wherein the status information comprises information on a current operational status of the home appliances and home automation devices and surrounding environment information.

3. The apparatus of claim 1, wherein the operation controlling unit is configured to produce an authorization approval signal for the connection to the home appliance and home automation device using a master identifier.

4. The apparatus of claim 1, wherein the operation controlling unit is configured to produce an information request signal for requesting the status information to the home appliance and home automation device.

5. The apparatus of claim 1, wherein the device interface unit is configured to communicate with an external server through an Internet-based network.

6. The apparatus of claim 5, wherein the information collection unit is configured to receive external underlying information for the storage thereof from the external server.

7. The apparatus of claim 6, wherein the external underlying information comprises an energy consumption and electricity rates by time, current external temperature, a weather change, and a temperature change.

8. The apparatus of claim 6, wherein the operation controlling unit is configured to analyze the status information and external underlying information, produce an operation control sequence having a minimum energy consumption by time, and produce the operation control signal in line with the operation control sequence.

9. The apparatus of claim 8, wherein the operation controlling unit is configured to produce a user approval request signal for receiving the approval of the operation control sequence from the user

10. The apparatus of claim 9, wherein the operation controlling unit is configured to produce a user alarm signal for informing the operation of the home appliance and the home automation device.

11. The apparatus of claim 10, further comprising:
a user interface unit configured to receive the user approval request signal and forward the received one to the user, and receive one of an approval signal and a rejection signal and forward the received one to the operation controlling unit.

12. A method for managing energy in a home, the method comprising:
sending an authorization approval signal including a master identifier to at least one of a home appliance and a home automation device that are placed in the home;
receiving the approval of the connection to the home appliance and home automation device using the master identifier;
sending an information request signal to the home appliance and the home automation device;
receiving identifiers and status information on the home appliance and the home automation device; and
producing an operation control signal to forward the same to the home appliance and the home automation device.

13. The method of claim 12, said producing the operation control signal comprises producing an operation control sequence having a minimum energy consumption by time.

14. The method of claim 12, further comprising:
after said producing the operation control signal,
producing a user approval request signal to forward it to the user; and
receiving one of an approval signal and a rejection signal from the user.
